(19) United States
(12) Patent Application Publication
(10) Pub. No.: US 2011/0253751 A1
(43) Pub. Date: Oct. 20, 2011

(54) ONE PIECE SPOUT FOR A GASOLINE FUELING NOZZLE

(76) Inventor: JULIUS FRIEDMAN, Covina, CA (US)

(21) Appl. No.: 13/086,687

(22) Filed: Apr. 14, 2011

Related U.S. Application Data
(60) Provisional application No. 61/325,125, filed on Apr. 16, 2010.

(51) Int. Cl. B05B 1/22

(52) U.S. Cl. 222/566; 222/568

(57) ABSTRACT

A one piece spout for Healy 700®, Healy 800®, and Healy 900® gasoline fuel nozzles having a strong structural integrity. The gasoline nozzle spout includes a one piece tube having a first end and a second end having different diameters, the first end is adapted to be introduced on an inlet opening of a fuel tank, and the second end is adapted to be secured to a nozzle of a gasoline pump.

### CROSS-REFERENCE TO RELATED APPLICATIONS

This application claims the benefit of priority to U.S. Provisional Application No. 61/325,125 filed Apr. 16, 2010, the contents of which are incorporated herein by reference.

### BACKGROUND OF THE INVENTION

The present invention generally relates to a spout for a gasoline fuel nozzle, and more particularly, to a one piece spout for a gasoline fuel nozzle and a method for producing the one piece spout for the Healy 700®, Healy 800®, and Healy 900® nozzles.

Various nozzle spouts are commercially available for use with the fuel dispensing systems. The nozzle spout for the Healy 700®, Healy 800®, and Healy 900®is made of two pieces having different diameters attached by using epoxy or glue. Unfortunately, the two pieces of the known nozzle spouts often separate due to weakness at the glue joint. The separation of the two pieces renders the gasoline nozzle useless by not pumping fuel, not recovering vapors, not minimizing post fueling drips, and leaking fuel during dispensing. The gas station owner is frequently faced with having to replace the nozzle spouts. To address some of the above problems, Franklin Fueling Systems has redesigned the threading of their spout in an attempt to fix this problem.

As can be seen, there is a need for nozzle spouts that do not require the use of epoxy or glue to provide strong structural integrity.

### SUMMARY OF THE INVENTION

In one aspect of the present invention, a gasoline nozzle spout includes a one piece tube having a first end and a second end having different diameters.

In another aspect of the present invention, a gasoline nozzle spout includes a one piece tube having a first end and a second end, a ring attached to the one piece tube, the tube has a diameter that tapers at a predetermined point.

These and other features, aspects and advantages of the present invention will become better understood with reference to the following drawings, description and claims.

### BRIEF DESCRIPTION OF THE DRAWINGS

FIG. 1 illustrates a front perspective view of a one piece spout for a gasoline fueling nozzle according to an exemplary embodiment of the present invention;

FIG. 2 illustrates an exploded perspective view of the one piece spout of FIG. 1;

FIG. 3 illustrates a side view of the one piece spout of FIG. 1; and

FIG. 4 illustrates a partial section view of the one piece spout of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a one piece spout for a gasoline fuel nozzle that has a strong structural integrity. Another embodiment of the present invention provides a method for producing the one piece spout according to an exemplary embodiment of the present invention.

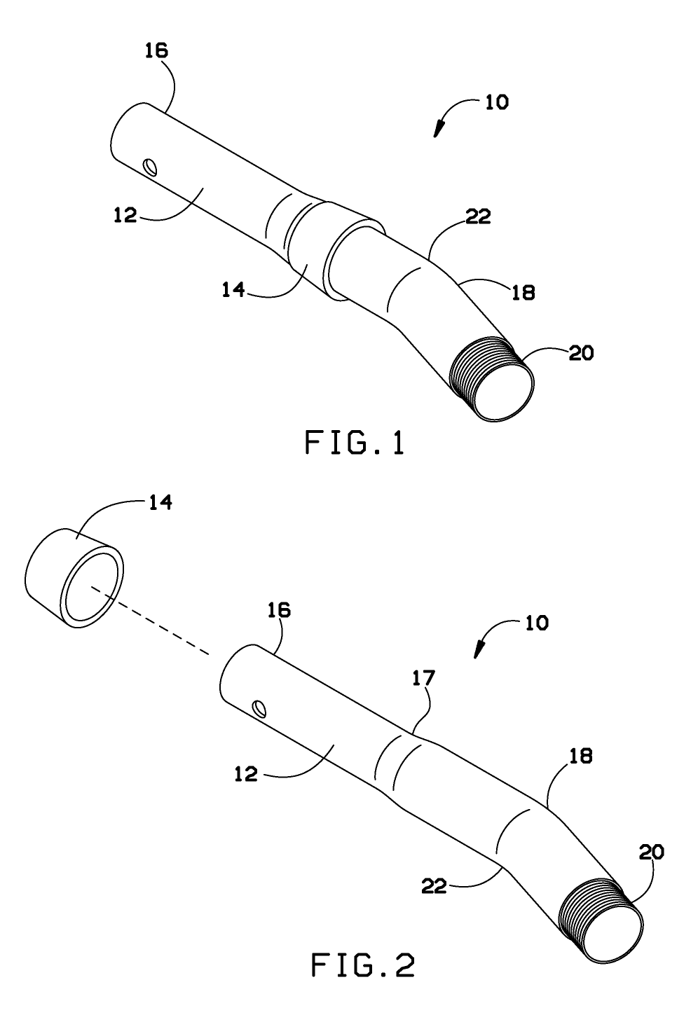

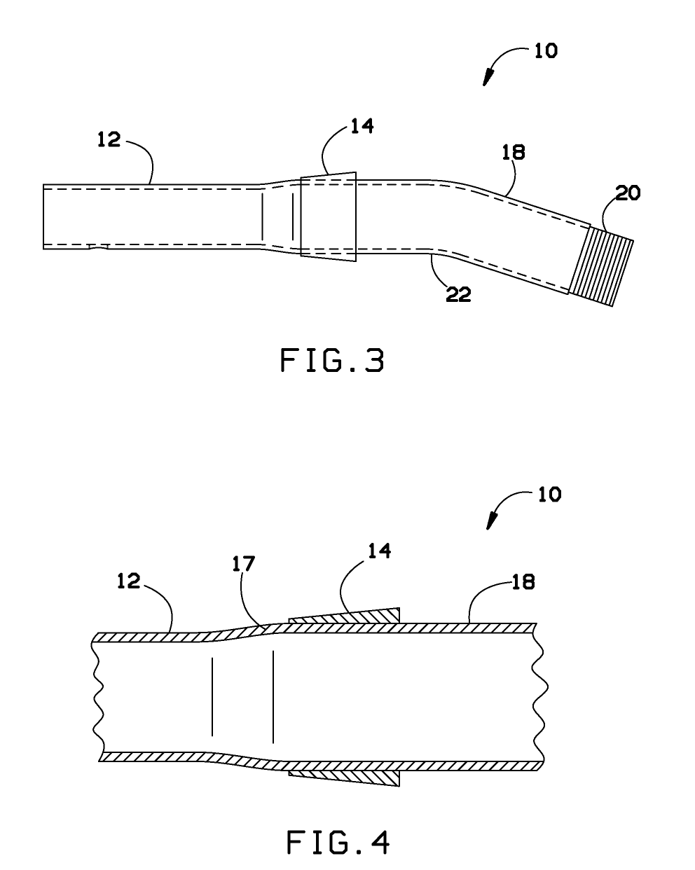

FIGS. 1-4 illustrate a one piece spout 10 according to an exemplary embodiment of the present invention. The one piece spout 10 may include a tube 12 and a ring 14 secured to the tube 12.

The tube 12 may include a first end 16 and a second end 18 having a thread 20. The first end 16 may be adapted to be introduced on an inlet opening (not shown) of a fuel tank (not shown) of a car (not shown), for example. The second end 18 may be adapted to be secured to the nozzle (not shown) of a pump (not shown).

The tube 12 may have a diameter that tapers at a point 17; thus, the first end 16 may have a diameter of a different size than a diameter of the second end 18. The diameter of the first end 16 may be slightly smaller than the diameter of the inlet opening (not shown) of the fuel tank (not shown). The diameter of the second end 18 may be slightly smaller than a diameter of the nozzle (not shown) of the pump (not shown). In some embodiments, the diameter of the first end 16 may be smaller than the diameter of the second end 18.

The second end 18 may include a bending point 22 for facilitating positioning the one piece spout 10 into the inlet opening (not shown) of the fuel tank (not shown).

The ring 14 may be slid through the first end 16 of the tube 12 until it reaches the point 17. The change of diameters occurring on point 17 may serve to stop the ring 14 from further sliding through the tube 12. The ring 14 may control the length of the tube 12 that may pass to the inlet opening (not shown) of the fuel tank (not shown). In some embodiments, the ring 14 may have a diameter that is slightly bigger than the diameter of the first end 18.

The tube 12 and the ring 14 may be made of a corrosion resistant material. In some embodiments, the tube 12 and the ring 14 may be made of stainless steel, aluminum, plastic, polyurethane, or composite material.

The one piece spout 10 may be manufactured by machining or by molding

The fuel may be dispensed out of the one piece spout 10 into the car fuel tank (not shown) or a gasoline container (not shown), for example.

The one piece spout 10 may reduce repair costs and downtime of the gasoline pump. In addition, the one piece spout 16 may eliminate the problems caused by the separation of the pieces of the currently known fuel spouts for the Healy 700®, Healy 800®, and Healy 900® nozzles. The one piece spout 10 may eliminate the need for in-house torque testing and threading of the spout conducted by the current manufacturer and for the certification process of the California Air Resources Board. Eliminating these steps may decrease the number of steps in the manufacturing process of not only the spout but the entire gasoline nozzle.

It should be understood, of course, that the foregoing relates to exemplary embodiments of the invention and that modifications may be made without departing from the spirit and scope of the invention as set forth in the following claims.

What is claimed is:

1. A gasoline nozzle spout comprising:
a one piece tube having a first end and a second end; and
wherein the first end has a diameter that is different from a diameter of the second end.

2. The gasoline nozzle spout according to claim 1, further comprising a thread on the second end.

3. The gasoline nozzle spout according to claim 1, wherein the tube has a diameter that tapers at a predetermined point:

4. The gasoline nozzle spout according to claim 1, wherein the diameter of the first end is smaller than the diameter of the second end.

5. A gasoline nozzle spout comprising:
a one piece tube having a first end and a second end;
a ring attached to the one piece tube; and
wherein the tube has a diameter that tapers at a predetermined point.

6. The gasoline nozzle spout according to claim 5, wherein the ring is attached to the predetermined point.

7. The gasoline nozzle spout according to claim 5, further comprising a thread on the second end.

8. The gasoline nozzle spout according to claim 5, wherein the diameter of the first end is smaller than the diameter of the second end.
